(19) United States
(12) Patent Application Publication
(10) Pub. No.: US 2007/0043866 A1
(43) Pub. Date: Feb. 22, 2007

(54) Predictive email actions and load prompts

(75) Inventors: Zachary A. Garbow, Rochester, MN (US); Robert H. Hamlin, Mantorville, MN (US); Clayton L. McDaniel, Rochester, MN (US); Emuejevoke J. Sanomi-Fleming, Douglasville, GA (US); Kenneth J. Trisko, Stewartville, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(73) Assignee: International Business Machines Corporation, Armonk, NY (US)

(21) Appl. No.: 11/207,066

(22) Filed: Aug. 18, 2005

(51) Int. Cl. G06F 15/173

(52) U.S. Cl. 709/226

(57) ABSTRACT

Methods, apparatus and articles of manufacture for determining and managing the impact, or probable impact, of electronic-mail messages on computer resources. In one embodiment, prior to sending a first electronic mail message to a plurality of intended recipients over a network, a prospective impact of the first electronic mail message on computer resources on the network should the first electronic mail message be sent is determined.

### BACKGROUND OF THE INVENTION

1. Field of the Invention

The present invention generally relates to data processing and, more particularly, processing to electronic mail.

2. Description of the Related Art

Electronic-mail (e-mail) is a widespread form of communication between users of computerized devices. Typically, e-mails are composed and sent using an e-mail client application. A given e-mail message may include payload in the form of text or in-line figures, as well as attachments (e.g., documents, pictures, video files).

As reliance on e-mail in various environments grows, so does the strain on the underlying computer resources needed to support the email traffic. In particular, increasing e-mail traffic requires more network bandwidth and more storage. The resource problem is compounded by the fact that email attachments are becoming increasingly larger in size and also by the fact that a given email message is often forwarded or replied to by a recipient. As such, a single email message proliferates into a plurality of messages.

Therefore, there is a need for methods and systems for managing email messages and managing resource usage in email environments.

### SUMMARY OF THE INVENTION

The present invention generally relates to a method, apparatus and article of manufacture for determining and managing the impact, or probable impact, of electronic-mail messages on computer resources.

In one embodiment, prior to sending a first electronic mail message to a plurality of intended recipients over a network, a prospective impact of the first electronic mail message on computer resources on the network should the first electronic mail message be sent is determined.

In another embodiment, determining the prospective impact comprises predicting a treatment of the first electronic mail message by at least one of the plurality of recipients upon receipt of the first electronic mail message.

In another embodiment, determining the prospective impact comprises determining a base load by multiplying the number of recipients by the size of the e-mail message.

In another embodiment, determining the prospective impact comprises determining a likelihood that the e-mail message will be responded to by at least one of the plurality of recipients upon receipt of the first electronic mail message by sending another e-mail message (e.g., sending a reply or forwarding a copy of the received e-mail message). This determination may be done repeatedly throughout the life of the email message or conversation thread.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a computerized apparatus configurable according to one embodiment of the present invention;

FIG. 2 is a computer network environment, according to one embodiment of the present invention;

FIG. 3 is a flow chart illustrating a determination of a load on a resource(s), according to one embodiment of the present invention;

FIG. 4 is a dialog box representative of a notification of excess load and prompting a user for mitigating action, according to one embodiment of the present invention;

FIG. 5 is a flow chart illustrating prediction of recipients' actions responsive to receiving an e-mail message and calculating/adjusting a corresponding load according to one embodiment of the present invention.

### DETAILED DESCRIPTION OF THE PREFERRED EMBODIMENTS

The present invention generally relates to a method, apparatus and article of manufacture for determining and managing the impact, or probable impact, of electronic-mail messages on computer resources. In one embodiment, prior to sending a first electronic mail message to a plurality of intended recipients over a network, a prospective impact of the first electronic mail message on computer resources on the network should the first electronic mail message be sent is determined. Determining the prospective impact may include predicting a treatment of the first electronic mail message by at least one of the plurality of recipients upon receipt of the first electronic mail message.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

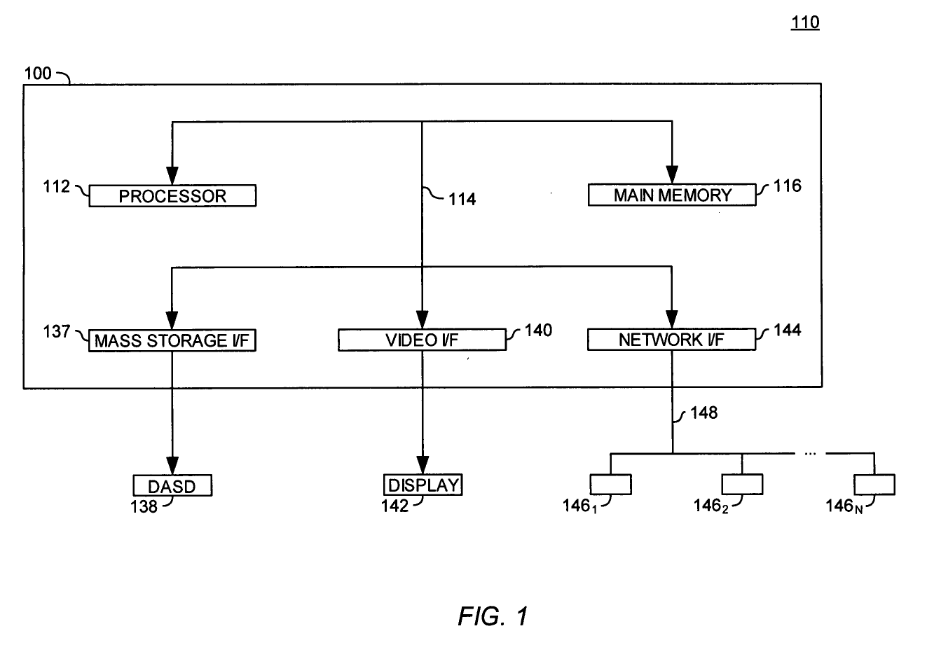

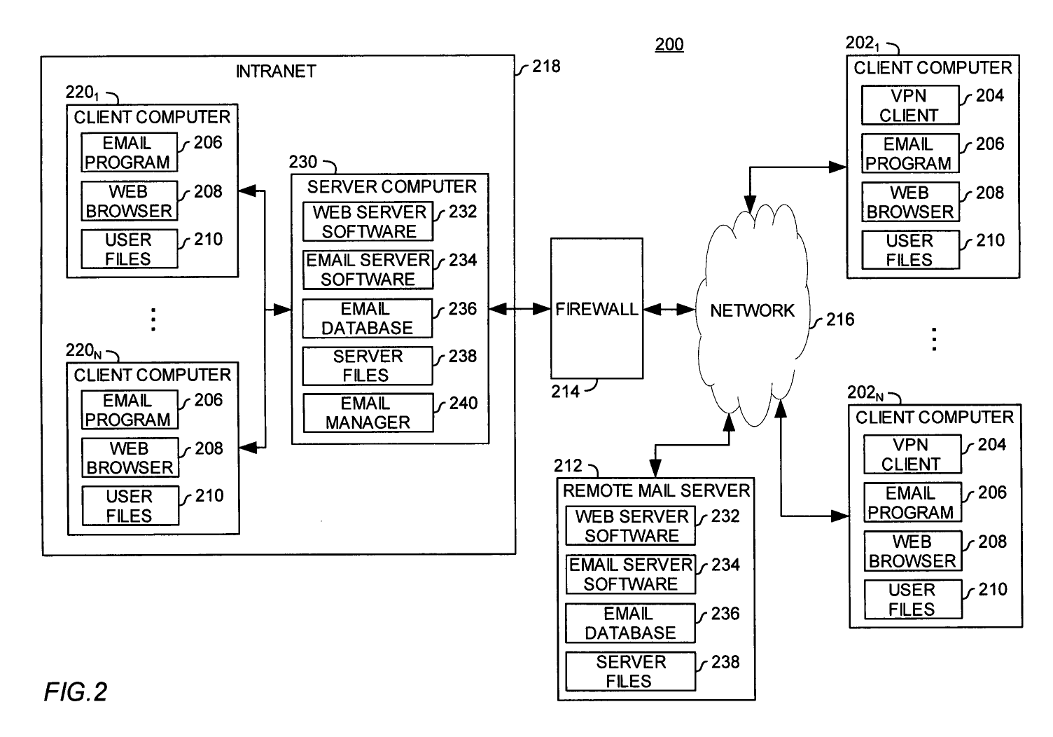

One embodiment of the invention is implemented as a program product for use with a computer system such as, for example, the computer 100 and/or network environment 200 shown in FIGS. 1-2 and described below. The program(s) of the program product defines functions of the embodiments (including the methods described herein) and can be contained on a variety of computer-readable media. Illustrative computer-readable media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such computer-readable media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

FIG. 1 shows a computer 100 (which is part of a computer system 110) that becomes a special-purpose computer according to an embodiment of the invention when configured with the features and functionality described herein. The computer system 100 may represent any type of computer, computer system or other programmable electronic device, including a client computer, a server computer, a portable computer, a personal digital assistant (PDA), a cell phone, an embedded controller, a PC-based server, a minicomputer, a midrange computer, a mainframe computer, and other computers adapted to support the methods, apparatus, and article of manufacture of the invention. The terms client computer and server computer are used herein merely for convenience in describing embodiments and in general may refer to any computer, including a computer containing both client-type software and server-type software.

Illustratively, the computer 100 is part of a networked system 110. In this regard, the invention may be practiced in a distributed computing environment in which tasks are performed by remote processing devices that are linked through a communications network. In a distributed computing environment, program modules may be located in both local and remote memory storage devices. In another embodiment, the computer 100 is a standalone device. For purposes of construing the claims, the term “computer” shall mean any computerized device having at least one processor. The computer may be a standalone device or part of a network in which case the computer may be coupled by communication means (e.g., a local area network or a wide area network) to another device (i.e., another computer).

In any case, it is understood that FIG. 1 is merely one configuration for a computer system. Embodiments of the invention can apply to any comparable configuration, regardless of whether the computer system 100 is a complicated multi-user apparatus, a single-user workstation, or a network appliance that does not have non-volatile storage of its own.

The computer 100 could include a number of operators and peripheral systems as shown, for example, by a mass storage interface 137 operably connected to a storage device 138, by a video interface 140 operably connected to a display 142, and by a network interface 144 operably connected to the plurality of networked devices 146 (which may be representative of the Internet). Although storage 138 is shown as a single unit, it could be any combination of fixed and/or removable storage devices, such as fixed disc drives, floppy disc drives, tape drives, removable memory cards, or optical storage. The display 142 may be any video output device for outputting viewable information.

Computer 100 is shown comprising at least one processor 112, which obtains instructions and data via a bus 114 from a main memory 116. The processor 112 could be any processor adapted to support the methods of the invention. In particular, the computer processor 112 is selected to support the features of the present invention.

The main memory 116 is any memory sufficiently large to hold the necessary programs and data structures. Main memory 116 could be one or a combination of memory devices, including Random Access Memory, nonvolatile or backup memory, (e.g., programmable or Flash memories, read-only memories, etc.). In addition, memory 116 may be considered to include memory physically located elsewhere in a computer system 110, for example, any storage capacity used as virtual memory or stored on a mass storage device (e.g., direct access storage device 138) or on another computer coupled to the computer 100 via bus 114. Thus, main memory 116 and storage device 138 could be part of one virtual address space spanning multiple primary and secondary storage devices.

FIG. 2 depicts an exemplary networked environment 200 in which email messages may be transmitted according to embodiments of the present invention. The networked environment 200 may comprise an intranet 218, a network 216, a remote mail server 212, and a plurality of client computers 2021 . . . 202N which may be outside of the intranet 218. The intranet 218 may contain a plurality of client computers 2201 . . . 220N as well as a server computer 230. Each computer in the intranet 218 may be connected to the network 216 by a firewall 214. Intranet 218 may be any network, including, for example, a corporate/office/enterprise intranet, university intranet, or home/personal intranet. Network 216 may also be any network, including a large wide-area network (WAN) such as the Internet. Each client computer 2021 . . . 202N and 2201 . . . 220N may be a computer system (e.g. the computer system 110 depicted in FIG. 1). The client computers 2021 . . . 202N and 2201 . . . 220N may be connected to one another through the network 216 and intranet 218 and also connected through the intranet 218 and network 216 to the server computer 230 and remote mail server 212.

Each of the servers 212, 230 may provide a variety of email services to each of the client computers 2021 . . . 202N and 2201 . . . 220N. These email services may be provided on a variety of different scales. For instance, the provided email services may include large Internet services such as Yahoo! Mail (™) or Hotmail (™). The email services may also include mid-size and smaller email services, such as enterprise level, corporate or business email services, university email services, and home or personally run email services.

In some cases, the servers 212, 230 may provide email services in one or more protocols. The provided email protocols may include the Post Office Protocol (POP, including, for instance, versions POP2 or POP3), the Simple Mail Transfer Protocol (SMTP), and Internet Message Access Protocol (IMAP), as well as any other appropriate protocol.

According to one embodiment of the invention, each server 212, 230 may have email server software 234 which implements each provided protocol and provides email services to each of the clients. In one embodiment, each client computer 2021 . . . 202N and 2201 . . . 220N may access the email services provided by the email server software 234 using an email program 206. When the email server software 234 receives an access request (e.g., a request to check, read, or send email) from the email program 206, the email server software 234 may access an email database 236 and use information within the email database 236 to process the request. The email database 236 may include any information, including sent email messages, sent email attachments, drafted messages, received email messages, received email attachments, user information, and any other information used by the email server software 234. The email database 236 may also include information regarding the respective user's habits relating to email, as will be described in more detail below.

In some cases, each client computer 2021 . . . 202N and 2201 . . . 220N may also store email information (e.g., in local user files 210) which may include email messages, email attachments and/or cached copies of email information stored in a remote email database 236. The email information in local user files 210 may also include information regarding the respective user's habits relating to email, as will be described in more detail below.

Client computers 2021 . . . 202N and 2201 . . . 220N depicted in FIG. 2 may access the email services provided by each of the server computers 212, 230 using a variety of access methods and configurations. Where client computers 2201 . . . 220N are located within intranet 218, the client computers 2201 . . . 220N may connect directly to the server computer 230 within the intranet 218 with an email program 206 configured to access the server computer 230. The email program 206 may use one or more of the protocols described above to access the email server software 234.

Where client computers 2021 . . . 202N outside of an intranet 218 access computers 230, 2201 . . . 220N inside the intranet 218, the external client computers 2021 . . . 202N may use a virtual private network (VPN) to create a connection. The VPN may be accessed by the client computers 2021 . . . 202N using a VPN client 204. Thus, in some cases, the VPN client 204 may be used in conjunction with the email program 206 to access the email services provided by the email server software 234 on the server computer 230. In other cases, where client computers 2021 . . . 202N and 2201 . . . 220N access a remote mail server 212 which is not within an intranet 218, the mail services provided by the server computer 212 may be accessed without the VPN client 204. In other embodiments, the VPN client may not be used to access either server computer 212, 230.

Each of the servers 212, 230 may also provide email services using a web based email service (also referred to as a webmail service, or Internet mail service). The web based email service may be implemented using web server software 232 on each server computer 212, 230 which provides each client computer 2021 . . . 202N and 2201 . . . 220N a series of web pages. According to one embodiment of the invention, each client computer 2021 . . . 202N and 2201 . . . 220N may use web browser software 208 or the email program 206 to access the web based email service. Each client computer 2021 . . . 202N and 2201 . . . 220N may access the web based email services provided by the server computers 212, 230 using a variety of protocols, including the Hypertext Transfer Protocol (HTTP), File Transfer Protocol (FTP), Gopher, Telnet,

The web pages provided by the web server software 230 may be used to access email services provided by the server computer 212, 230. Accordingly, the web pages may utilize one or more forms, such as Hypertext Markup Language (HTML) forms, and/or one or more scripts and/or applets to process requests from client computers 2021 . . . 202N and 2201 . . . 220N. The scripts used to access the email services may include scripts executed by the server computers 212, 230. Scripts executed by the server computers 212, 230 (referred to as server-side scripts) may be executed, for example, by the web server software 232, email server software 234, or other server software. The scripts used to access the email services may also include scripts executed by the client computers 2021 . . . 202N and 2201 . . . 220N (referred to as client-side scripts) and may be executed, for example, by the email program 206, web browser 208, or other client software.

Networked environment 200 is merely an exemplary networked environment and other configurations, variations, and components of the networked environment (such as routers, storage servers, file servers, etc. . . , not depicted) should be readily apparent to one of ordinary skill in the art. For instance, in some embodiments, multiple separate computers may be used as web and email servers, with one or more computers executing for the web server software 232 and one or more computers executing email server software 234. In some cases, each email service may provide several email domains wherein a separate email server provides email service to each domain and wherein an email router is used to route all email received by the email service to the appropriate email server. In general, embodiments of the invention may be adapted for use in any situation in which electronic messages are transmitted.

Regardless of the particular architecture, supporting electronic mail requires sufficient resources, including sufficient processing and storage resources. To this end, embodiments of the present invention provide solutions directed to managing the resources consumed by e-mail messages. In one embodiment, such management is performed by an e-mail manager. Illustratively, FIG. 2 shows an e-mail manager 240 resident on the server computer 230. However, the e-mail manager 240, or other instances of an e-mail manager, may be resident on the remote mail server 212 and/or on the various client computers 2021 . . . 202N and 2201 . . . 220N. In another embodiment, one or more agents may reside on the various client computers 2021 . . . 202N and 2201 . . . 220N cooperate with e-mail managers to implement embodiments of the invention.

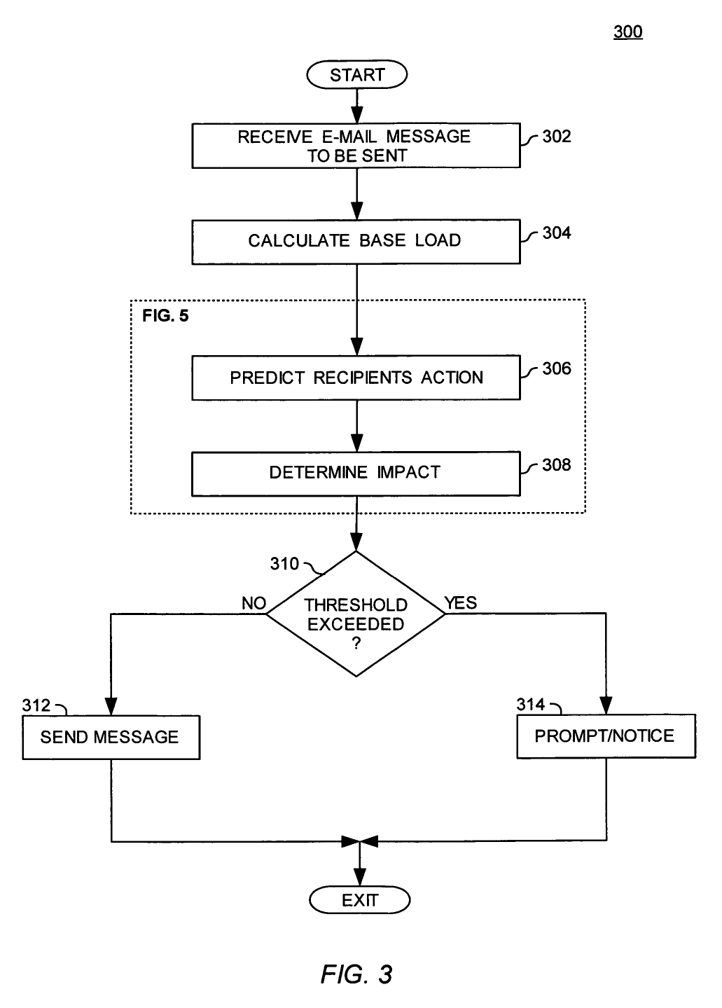

In one embodiment, the e-mail manager 240 takes steps to preemptively determine the impact, or possible impact, on an e-mail message to be sent to one or more recipients. One embodiment of a method 300 implemented by the e-mail manager 240 shown in FIG. 3. Method 300 enters at step 302 where the e-mail manager 240 receives an e-mail message to be sent to one or more recipients. The e-mail message may be received by the e-mail manager 240, for example, when the sender clicks on a “send” button of an e-mail program 206 (alternatively, receipt may be triggered on the basis of some other event, or may be occur dynamically at any point). However, prior to allowing the message to be sent (e.g., prior to providing the message to the e-mail server software 234 for routing to the various appropriate destinations), the e-mail manager 240 makes a determination about the resource impact of the e-mail message.

In one embodiment, the e-mail manager 240 calculates a base load at step 304. The “base load” is generally a quantification of the resource impact on a given system (e.g., the intranet 218) sending the given e-mail message will have, based on the named recipients in the e-mail and the size of the e-mail. As is well-known, users may designate multiple recipients under a common group name. Accordingly, it is contemplated that determining the base load includes first resolving the individual recipients in a recipient group specified in the e-mail. For purposes of differentiating types of recipients, the recipients explicitly identified by the sender in the original e-mail (whether individually or in a group) are referred to herein as the “primary recipients” or “direct recipients”. Recipients of subsequent instances of the original email message (e.g., recipients of a forwarded instance of the email message, or the original sender who receives a reply containing the history of the email thread, including the original message) or other email messages prompted by receipt of the original email message (i.e., a reply not containing any history) are referred to herein as the “secondary recipients” or “indirect recipients”. The base load may then be determined by multiplying the number of primary recipients by the size of the e-mail. It is contemplated that the size of the e-mail may include the payload of the e-mail in the message body, as well as any attachments.

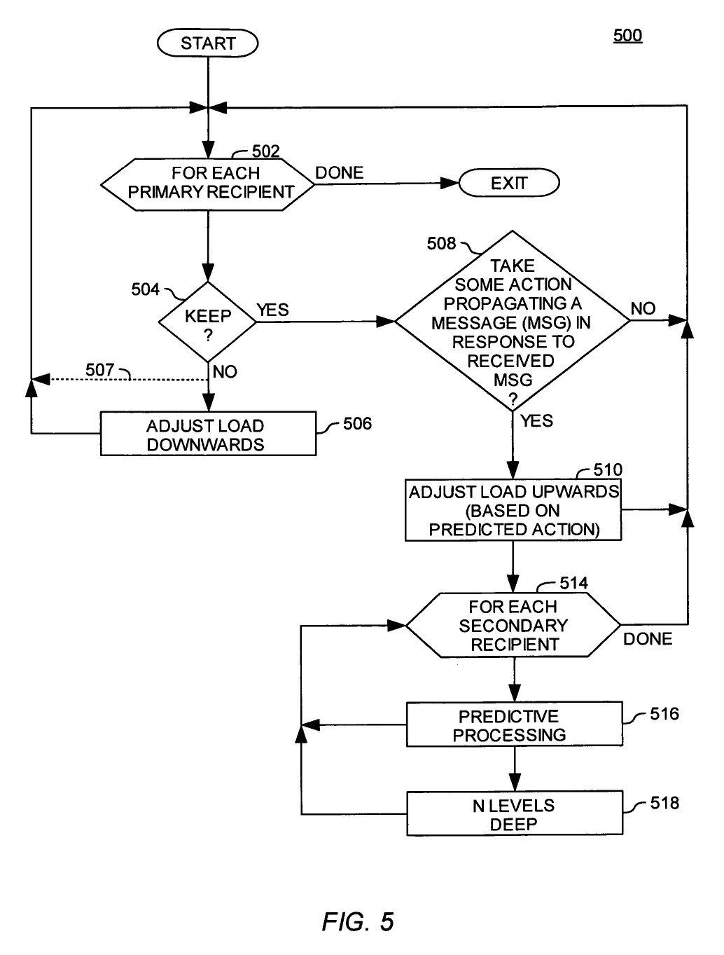

Having determined the base load, the e-mail manager 240 then predicts (step 306) one or more of the primary recipients' actions with respect to the e-mail message upon receipt. Embodiments for predicting the recipients' actions are described below (e.g., with respect to FIG. 5). In one embodiment, the purpose of predicting the recipients' actions is to quantify the possible prospective impact of sending the e-mail message on the system resources of the network over which the e-mail message is sent. For purposes of explaining a given embodiment, the predicted (or estimated) impact based on the predicted recipients' action may be referred to herein as the “indirect load”.

Having determined the base load and the indirect load, the e-mail manager 240 then determines (step 308) a predicted/estimated impact sending the e-mail message may have on the system resources. In one embodiment, if the determined impact does not exceed a predefined threshold (step 310), then the e-mail manager allows the e-mail message to be sent (step 312). Otherwise, if the determined impact does exceed the predefined threshold (step 310), the e-mail manager 240 may initiate some mitigating action (step 314).

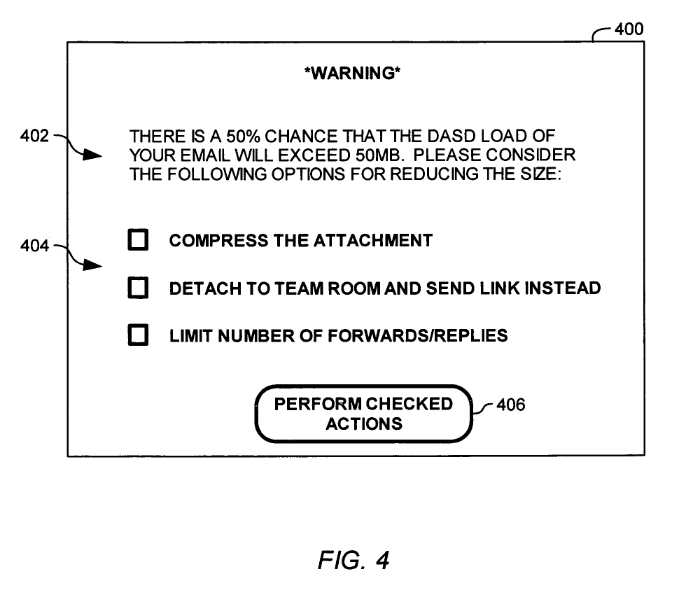

In one embodiment, the sender receives a notice of the predefined threshold being exceeded and/or a prompt to select from one or more possible actions. FIG. 4 shows a representative dialog box 400 that illustrates a notice 402 and a prompt 404. The notice informs the sender that there is a 50% chance that the DASD load of the e-mail message will exceed 50 MB. Under these conditions the sender is not permitted to send the e-mail message as is. Accordingly, the prompt 404 provides the user a number (in this case, three) of mitigating actions from which to choose. The illustrative actions include compressing any attachments to the e-mail message, sending a link to the resource instead of an attachment, and setting a limit on the number of forwards and/or replies that the primary and secondary recipients may make in response to receiving the e-mail message. After selecting (i.e., checking) the desired action(s), the sender clicks on a button 406 to perform the selected actions. If the selected actions sufficiently reduce the prospective impact on system resources (i.e., below the predefined threshold), then the e-mail manager 240 may allow the e-mail message to be sent. On the other hand, if the selected actions do not reduce the prospective impact on the system resources below the predefined threshold, the e-mail manager 240 may not allow the e-mail message to be sent and instead prompt the sender to take further mitigating actions.

In addition to, or as an alternative to, prompting for manual intervention by the sender, automated intervention (e.g., by the e-mail manager 240) is also contemplated. For example, if the e-mail message exceeds the predefined threshold, the e-mail manager 240 may automatically compress all files without prompting the sender (although it is contemplated that the sender may be notified of the compression). In one embodiment, one or more automated actions may be taken based on predefined user configured settings designating the action(s).

The foregoing actions (whether manually or automatically selected) are merely illustrative, and any variety of possible mitigating actions is contemplated. For example, the sender may be informed that the attachment about to be sent with the e-mail has already been sent to one or more of the specified primary recipients. A particular situation in which this may be detected is where the sender has selected to “reply to all” with history. In this situation, the sender may be given the option of not sending the attachment to those recipients who have previously received the attachment. In one embodiment, which recipients have already received a given attachment for a particular e-mail thread may be determined by assigning a unique ID to each attachment. Each thread could then be checked for the presence of IDs corresponding to currently attached objects. It is also contemplated that those recipients who receive a given attachment can be tracked by embedding metadata (identifying those recipients and the respective attachment ID) in the email threads. In this way, for a given message in a thread, that includes an attachment and designates recipients who previously received the attachment (as determined from the metadata), the attachment can be selectively removed (i.e., not sent) to those designated recipients. In another embodiment, the sender may be given the option of using a relatively more compressed file format, e.g., a JPEG format instead of a bitmap format.

It is also contemplated that the mitigating actions automatically selected or made available to the user for manual selection are determined based upon a real-time assessment of resource availability. For example, during peak hours when network traffic is high the e-mail manager 240 may set the predefined threshold for allowed system resource consumption lower than the threshold would be set during off-peak hours when network traffic is low. Similarly, during times when the e-mail manager 240 determines that the available disk space is low, the predefined threshold may be set relatively lower.

It is also contemplated that the mitigating actions may be selected based upon the authorization/privilege level of the particular user sending the e-mail message. For example, a user having administrator level privileges may be allowed to send larger e-mails than a user not having administrator level privileges.

Referring now to FIG. 5, a method 500 is shown for predicting the actions of primary and secondary recipients according to one embodiment of the invention. In one embodiment, the method 500 is performed by the e-mail manager 240. For purposes of illustration, FIG. 5 will be described in the context of predicting the direct access storage device (DASD) load associated with sending an e-mail message. Accordingly, the base load (determined at step 304 off FIG. 3) and the indirect load in this illustration are reflective of the impact of an e-mail message on storage. However, the impact on other system resources (e.g., CPU usage) is also contemplated.

The method 500 begins by entering a first loop (step 502) performed for each primary recipient named in the e-mail message. At step 504, the method 500 predicts whether the given primary recipient will keep (as opposed to delete) the e-mail message upon receipt. In this context, “keeping” the e-mail message means that the given primary recipient maintains a copy of the e-mail message for a period of time after reading the e-mail message (recognizing that, of course, at some point in time the e-mail message will inevitably be deleted). The alternative to keeping the e-mail message is deleting the e-mail message immediately (or with x minutes of receiving or opening the message) upon reading the e-mail message. In one embodiment, if the prediction is that the primary recipient will delete the e-mail message upon receipt, then the indirect load can be adjusted downwards (i.e., reduced) to reflect a relatively reduced impact on system resources. Alternatively, as represented by the dashed logic leg 507, no adjustment to the indirect load is made. This latter approach is consistent with the fact that a decision by a recipient to delete the e-mail message upon receipt does not avoid the initial hit on storage once the e-mail messages sent.

If, on the other hand, the method 500 predicts that the given primary recipient will keep the e-mail message upon receipt, then the method 500 proceeds to step 508 to predict whether the given primary recipient will take some action causing propagation of the received e-mail message, or transmission of some other e-mail message sent in response to receiving the received e-mail message. In other words, step 508 determines/predicts whether additional resources will be consumed as a result of an action taken by the primary recipient in response to receiving the e-mail message. In one embodiment, the method 500 at step 508 predicts a particular action to be taken, e.g., forwarding, replying, etc. In an alternative embodiment, the method 500 at step 508 predicts only whether some action resulting in consumption of additional resources will be taken.

If step 508 is answered negatively, the method 500 returns to step 502 to begin predictive processing for the next primary recipient designated in the e-mail message. On the other hand, if step 508 is answered affirmatively, the indirect load is adjusted upwards at step 510. In one embodiment, the adjustment of the indirect load at step 510 is based upon the predicted action the primary recipient may take. For example, if the predicted action is to “reply to all with history”, then the adjustment to the indirect load is relatively larger than if the predicted action is to forward a single instance of the received e-mail message. As noted above, however, in an alternative embodiment, the method 500 at step 508 does not predict a particular action, but merely whether any action resulting in the consumption of additional resources is predicted to occur. In this case, the adjustment to the indirect load at step 510 may be a predefined, singular value.

In one embodiment, after determining (at step 508) that one or more additional e-mail messages will be sent by a given primary recipient (and after adjusting the indirect load accordingly at step 510), the method 500 may make similar predictions and calculations with respect to each secondary recipient, as represented by the sub-loop entered at step 514. Block 516 is representative of the same or similar steps taken for the primary recipients, i.e., steps 504, 506 508, and 510 and logic leg 507). This processing may be recursively performed for each level of secondary recipients, since a given secondary recipient may themselves forward or reply (for example) to the e-mail message they receive. Accordingly, block 518 represents some level, N, of recursiveness. Of course, it is also contemplated that only the primary recipients' actions will be predicted and accounted for, without regard for possible actions by secondary recipients.

In the foregoing embodiment, a binary predictive model is employed. That is, the recipients are predicted to take one action or another (e.g., keep or delete a message; take responsive resource-consuming action, or not). In another embodiment, a probabilistic approach may be employed. That is, a probability of various possible actions is determined. For example, the probability that a given recipient (primary or secondary) keeps an e-mail message may be determined to be 40%, while the probability that the given recipient deletes the e-mail message is therefore determined to be 60%. The predicted resource load may then be expressed, for example, as a percentage probability of a determined resource consumption, as illustrated in FIG. 3. Persons skilled in the art will recognize that the foregoing are merely illustrative embodiments, and the other embodiments within the scope of the invention are possible.

In one embodiment, the predictive determinations may distinguish between particular primary and/or secondary recipients, while in another embodiment no distinction is made and every recipient is treated objectively/equally. In the former embodiment where recipients are distinguished, the predictive determinations may be done with recipient-specific metrics. Such metrics may be stored, for example, in the email database 236 and/or in the various respective user files 210. Then, when making a particular prediction, the e-mail manager 240 (possibly in cooperation with client-resident agents) may access the appropriate database/file to retrieve recipient-specific information. Exemplary recipient-specific information may include historical actions the given recipient has taken in the past with respect to the particular sender about to send the e-mail message in question. If the historical information reflects that the given recipient typically deletes e-mail messages received from the particular sender without taking any other responsive action, the indirect load can be adjusted accordingly, e.g., reduced or left unchanged; or, alternatively, an appropriate probability can be calculated reflecting that the given recipient is likely to take no action resulting in additional resource consumption.

Other resources of information which may be used to predict a given recipient's action in response to receiving an e-mail message, include the recipient's calendar and instant messaging status. For example, if the recipient's calendar indicates that the recipient is currently in a meeting or on vacation, the recipient is then less likely to respond immediately or at all.

The likelihood of a given recipient's response may also be determined on the basis of whether the recipient is designated in the To: line of the e-mail or the cc: line. A recipient designated in the To: line is presumably more likely to respond. In a business organization, the organizational hierarchy (chain of command) can also be used to advantage. For example, an e-mail message addressed to both a sender's supervisor and team member (having equal or lesser hierarchical status as the sender) may be more likely to result in a response by the supervisor than the team member.

Another piece of information which may be used to advantage in making a prediction is whether or not the e-mail message was sent using a distribution list. In a particular embodiment, each distribution list may be characterized using a particular attribute reflective of whether or not recipients on the list would normally take responsive action upon receiving a given e-mail addressed to the distribution list. For example, a particular distribution list may be used merely to distribute notifications that do not require or do not allow response. In this case, the indirect load associated with sending an e-mail to such a distribution list could be presumed to be zero (i.e., no indirect load).

In yet another embodiment, the text semantics within the body of the e-mail message itself may be used to make a prediction regarding the likelihood of responsive action by the one or more recipients. For example, the body of the e-mail message may be examined for keywords/phrases or characters such as “FYI”, “Please respond”, question marks, etc. An e-mail message containing “FYI” is less likely to produce responsive action than an e-mail message containing the phrase “Please respond”. Similarly algorithms capable of detecting the tone of the language within the e-mail message can be used to advantage. User-set relevancy attributes such as “high importance”, “low importance”, etc. can be used as a basis to make a prediction regarding the likelihood of responsive action.

In another embodiment, the mail capacity of the recipient may be determined and used to advantage. For example, if the mail capacity of a given recipient is currently exceeded, then the e-mail message may not be successfully sent to the given recipient. It should be noted that in this case the base load (as opposed to the indirect load) may be adjusted downward, since the sender may be notified of the particular recipient's mailbox condition and then removed from the recipient list.

Accordingly, a variety of factors and information may be considered and used as a basis for making a prediction of recipient responsiveness with varying degrees of specificity. In one embodiment, precisely which recipient actions can be predicted may depend upon what information the e-mail manager 240 has access to. By way of illustration only, Table I itemizes recipient actions that could be predicted if only the sender's user information (e.g., mail file and user habits) are available; while Table II itemizes recipient actions that could be predicted if both the sender's and recipient's user information are available.

TABLE I
Reply to sender
Reply to all
Reply with history
Length of response
Time until response
Whether response will contain attachments, and likely size of such
attachments
Length of e-mail thread, i.e., number of back and forths before e-mail
thread terminates because no one takes further responsive action and/or
deletes the e-mail
Tone of response
Content of response

TABLE II

Delete
Forward
How long until deletion
Filing into separate folder
Archiving
No action
Detach/delete only the attachments

It is also contemplated that the e-mail manager 240 (or other software) may analyze the accuracy of predictions. The analysis may be done to measure the quality of prediction and/or done by the e-mail manager 240 to calibrate itself. In a particular embodiment, a learning algorithm (e.g., neural network) may be employed for this purpose. In this way, the predictive quality may improve with time.

Further, while the present application provides a number of embodiments for making predictions regarding how a recipient will respond to a received e-mail message, these embodiments are merely illustrative. Persons skilled in the art will recognize other techniques for making the desired predictions. One example of how e-mail actions may be predicted using statistics is described at “http://www.hciresearch.hcii.cs.cmu.edu/complexcollab/pubs/paperPDFs/chi2005_dabbi sh.pdf”. It is contemplated that any variety of other techniques may be used.

While the foregoing is directed to embodiments of the present invention, other and further embodiments of the invention may be devised without departing from the basic scope thereof, and the scope thereof is determined by the claims that follow.

What is claimed is:

1. A computer-implemented method for managing resource usage of electronic mail messages, the method comprising:
providing a first electronic mail message specifying a plurality of intended recipients of the first electronic mail message; and
prior to sending the first electronic mail message to the plurality of intended recipients over a network, determining a prospective impact of the first electronic mail message on computer resources on the network should the first electronic mail message be sent; wherein determining the prospective impact comprises predicting a treatment of the first electronic mail message by at least one of the plurality of recipients upon receipt of the first electronic mail message.

2. The method of claim 1, wherein predicting comprises determining a probability of at least one of the plurality of recipients sending a second electronic mail message in response to receiving the first electronic mail message.

3. The method of claim 2, wherein determining a probability of at least one of the plurality of recipients sending a second electronic mail message in response to receiving the first electronic mail message comprises determining a probability that at least one of the plurality of recipients will forward the first electronic mail message.

4. The method of claim 1, wherein determining the prospective impact comprises multiplying the number of the plurality of recipients by a size of the first electronic mail message.

5. The method of claim 1, wherein the determined prospective impact is a measure of an amount of storage space that may be consumed should the first electronic mail message be sent.

6. The method of claim 1, wherein the prospective impact is determined to exceed a predetermined threshold, and further comprising:
notifying a sender of the first electronic mail message that the predetermined threshold is exceeded; and
prompting the sender to take an action designed to reduce the prospective impact on the computer resources.

7. The method of claim 1, wherein the prospective impact is determined to exceed a predetermined threshold, and further comprising:
initiating an automated, predefined action designed to reduce the prospective impact on the computer resources.

8. A computer readable storage medium containing a program which, when executed, performs an operation of managing resource usage of electronic mail messages, the operation comprising:
receiving a first electronic mail message specifying a plurality of intended recipients of the first electronic mail message; and
prior to sending the first electronic mail message to the plurality of intended recipients over a network, determining a prospective impact of the first electronic mail message on computer resources on the network should the first electronic mail message be sent; wherein determining the prospective impact comprises predicting a treatment of the first electronic mail message by at least one of the plurality of recipients upon receipt of the first electronic mail message.

9. The computer readable storage medium of claim 8, wherein predicting comprises determining a probability of at least one of the plurality of recipients sending a second electronic mail message in response to receiving the first electronic mail message.

10. The computer readable storage medium of claim 9, wherein determining a probability of at least one of the plurality of recipients sending a second electronic mail message in response to receiving the first electronic mail message comprises determining a probability that at least one of the plurality of recipients will forward the first electronic mail message.

11. The computer readable storage medium of claim 8, wherein determining the prospective impact comprises accounting for the number of the plurality of recipients.

12. The computer readable storage medium of claim 8, wherein determining the prospective impact comprises multiplying a number of the plurality of recipients by a size of the first electronic mail message.

13. The computer readable storage medium of claim 8, wherein the determined prospective impact is a measure of an amount of storage space that may be consumed should the first electronic mail message be sent.

14. The computer readable storage medium of claim 8, wherein the prospective impact is determined to exceed a predetermined threshold, and further comprising:
notifying a sender of the first electronic mail message that the predetermined threshold is exceeded; and
prompting the sender to take an action designed to reduce the prospective impact on the computer resources.

15. The computer readable storage medium of claim 8, wherein the prospective impact is determined to exceed a predetermined threshold, and further comprising:
initiating an automated, predefined action designed to reduce the prospective impact on the computer resources.

16. A computerized apparatus, comprising a processor, a memory containing an e-mail manager and a network interface for connecting to a network; wherein the e-mail manager is configured to perform an operation of managing resource usage of electronic mail messages, the operation comprising:
receiving a first electronic mail message specifying a plurality of intended recipients of the first electronic mail message; and
prior to sending, over the network, the first electronic mail message to the plurality of intended recipients over a network, determining a prospective impact of the first electronic mail message on computer resources on the network should the first electronic mail message be sent; wherein determining the prospective impact comprises predicting a treatment of the first electronic mail message by at least one of the plurality of recipients upon receipt of the first electronic mail message.

17. The apparatus of claim 16, wherein predicting comprises determining a probability of at least one of the plurality of recipients sending a second electronic mail message in response to receiving the first electronic mail message.

18. The computer readable storage medium of claim 16, wherein determining the prospective impact comprises multiplying a number of the plurality of recipients by a size of the first electronic mail message.

19. The computer readable storage medium of claim 16, wherein the determined prospective impact is a measure of an amount of storage space that may be consumed should the first electronic mail message be sent.

20. The computer readable storage medium of claim 16, wherein the prospective impact is determined to exceed a predetermined threshold, and further comprising:
notifying a sender of the first electronic mail message that the predetermined threshold is exceeded; and
prompting the sender to take an action designed to reduce the prospective impact on the computer resources.
